(19) United States
(12) Patent Application Publication
(10) Pub. No.: US 2006/0192863 A1
(43) Pub. Date: Aug. 31, 2006

(54) Camera that stores pictures on a remote system

(76) Inventor: Charles E. Evans, Corvallis, OR (US)

Correspondence Address: AVAGO TECHNOLOGIES, LTD., P.O. BOX 1920, DENVER, CO, 80201-1920, US

(21) Appl. No.: 11/068,152

(22) Filed: Feb. 28, 2005

(51) Int. Cl. H04N 5/76

(52) U.S. Cl. 348/231.99

(57) ABSTRACT

A digital camera includes mechanisms for storing a digital picture on a remote system via an existing communication infrastructure. A digital camera according to the present teachings enables a user of a digital camera to overcome the storage limitations of the digital camera even when away from their computer. In addition, a digital camera according to the present teachings enables a user of a digital camera to present their digital pictures on a personal web page for wide-spread access by friends and family.

### BACKGROUND

A digital camera may include an imaging apparatus for acquiring digital pictures and a picture memory for storing the acquired digital pictures. One example of a picture memory for a digital camera is a built-in memory, e.g. an internal flash memory or other type of internal memory. Another example of a picture memory for a digital camera is a removable media, e.g. a removable memory card.

A picture memory for a digital camera may have the capacity to store only a limited number of pictures in comparison to the number of pictures a user of the digital camera may wish to retain. For example, a built-in picture memory may provides a relatively limited storage capacity. Similarly, a removable memory card may have a limited storage capacity.

A user of a digital camera may transfer a set of digital pictures stored on its picture memory to a computer system, e.g. a personal computer system. The storage capacity of a computer system may enable the user of the digital camera to save large numbers of acquired digital pictures and overcome the relatively limited storage capacities of built-in picture memories or removable memory cards.

A user of a digital camera may transfer a set of digital pictures stored on its picture memory to a computer system by physically connecting the digital camera to the computer system via a standard interface, e.g. USB, firewire, etc. Alternatively, a computer system may include and a memory card reader and a user of a digital camera may transfers a set of digital pictures obtained by the digital camera to the computer system by removing the memory card from the digital camera and inserting the memory card into the memory card reader of the computer system.

Unfortunately, it may not be possible or practical under a variety of circumstances to physically connect a digital camera to a computer system or to transfer a memory card from a digital camera into a memory card reader of a computer system. For example, the user of a digital camera may be away from their computer system, e.g. traveling on vacation, when the storage capacity of the picture memory of the digital camera is reached.

### SUMMARY OF THE INVENTION

A digital camera is disclosed that includes mechanisms for storing a digital picture on a remote system via an existing communication infrastructure. A digital camera according to the present teachings enables a user of a digital camera to overcome the storage limitations of the digital camera even when away from their computer. In addition, a digital camera according to the present teachings enables a user of a digital camera to present their digital pictures on a personal web page for wide-spread access by friends and family.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a digital camera that stores a digital picture on a remote system using an existing communication infrastructure according to the present teachings;

FIG. 2 shows one embodiment of a digital camera according to the present teachings;

FIG. 3 illustrates a method for communication between a digital camera and a remote system in one embodiment.

### DETAILED DESCRIPTION

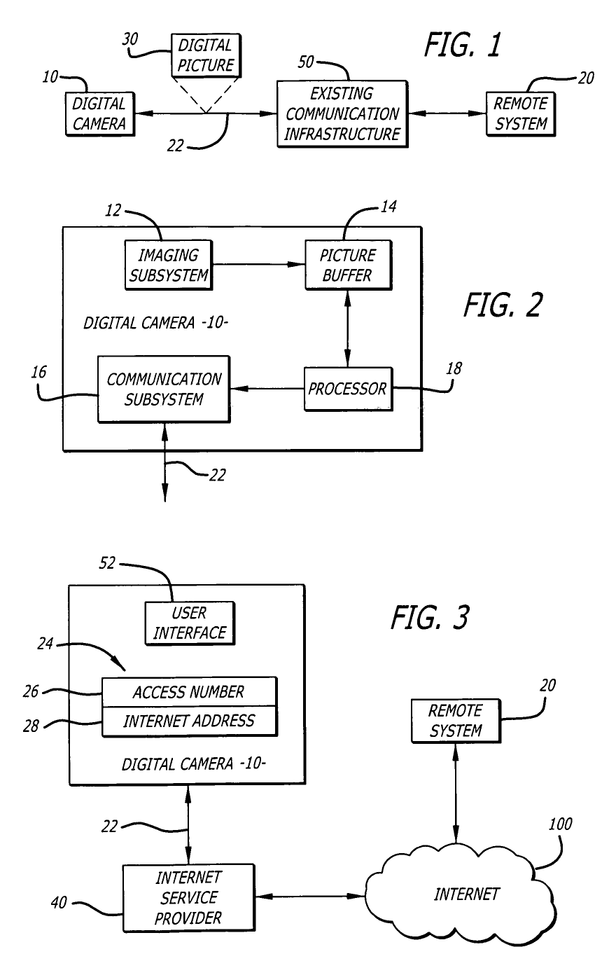

FIG. 1 shows a digital camera 10 according to the present teachings. The digital camera 10 is capable of acquiring a digital picture 30 and storing the digital picture 30 on a remote system 20 using an existing communication infrastructure 50. The existing communication infrastructure 50 is accessible via a communication link 22 to the digital camera 10.

The existing communication infrastructure 50 may include any combination of public switched telephone networks including cellular networks. The existing communication infrastructure 50 may include the communication infrastructure of the Internet.

The capability to transfer digital pictures to the remote system 20 enables a user of the digital camera 10 to acquire large numbers of digital pictures without the storage limitations of the digital camera 10. For example, the user of the digital camera 10 may acquire large numbers of digital pictures and save the digital pictures on the remote system 20 without carrying large amounts of removable media for the digital camera 10.

The digital pictures obtained with the digital camera 10 may accumulate on the remote system 20 for later access by the user of the digital camera 10. For example, the user of the digital camera 10 may acquire large numbers of digital pictures on a trip, e.g. a vacation, and save the digital pictures on the remote system 20 for access upon a return from the trip.

The communication link 22 may be a wireless communication link. Alternatively, the communication link 22 may be a wire-based communication link. Example implementations for the communication link 22 include a telephone link, e.g. a cellular or landline, Ethernet, Bluetooth, 802.11(b), Wi-Fi, etc. The communication link 22 may provide direct or indirect communication to the Internet.

In one embodiment, the digital camera 10 transfers the digital picture 30 to the remote system 20 as soon as the digital picture 30 is acquired. Alternatively, the digital camera 10 may internally store the digital picture 30 for a later transfer to the remote system 20 while the communication link 22 is unavailable. For example, the digital camera 10 may internally store the digital picture 30 while the digital camera 10 is out of range of a cellular base station or disconnected from a wire-based communication link. The digital camera 10 may automatically transfer the digital picture 30 to the remote system 20 when the communication link 22 becomes available, e.g. when in range of a cellular base station or when connected to a telephone line.

The remote system 20 may be a computer system, e.g. a personal computer system belonging to the user of the digital camera 10. The user of the digital camera 10 may use the communication link 22 to save digital pictures on their own personal computer located at their home even while they are traveling away from home.

The remote system 20 may be a system of an internet service provider. The remote system 20 may be a web server used by the internet service provider to provide a personal web page service to the user of the digital camera 10. A user of the digital camera 10 may use the existing communication infrastructure 50 to save digital pictures on their own personal web page on the remote system 20. For example, a personal web page may be used to provide friends and family with access to the vacation pictures of the user of the digital camera 10.

The remote system 20 may be a web site that provides a web-based storage and/or web page service to a user of the digital camera 10. A user of the digital camera 10 may use the existing communication infrastructure 50 to save digital pictures on a web-based storage service or web page service of a web site.

FIG. 2 shows the digital camera 10 in one embodiment. The digital camera 10 in this embodiment includes an imaging subsystem 12, a picture buffer 14, a communication subsystem 16, and a processor 18.

The imaging subsystem 12 includes an arrangement of optics and image sensors and related apparatus for acquiring the digital picture 30. One example of an image sensor is a solid-state imaging array, e.g. a charge-coupled device (CCD) array. The digital picture 30 acquired by the imaging system 12 includes a set of raw digital pixel data, e.g. pixel cell samples scanned out of a CCD array.

The imaging subsystem 12 transfers the acquired digital picture 30 into the picture buffer 14. The picture buffer 14 may be an internal memory in the digital camera 10 or may be a removable storage media, e.g. a memory card. The processor 18 may compress the digital picture 30 stored in the picture buffer 14. For example, the processor 18 may perform JPEG compression on the digital picture 30 stored in the picture buffer 14. Alternatively, the digital picture 30 may be compressed before being stored in the picture buffer 14.

The processor 18 obtains the digital picture 30 from the picture buffer 14 and transfers the digital picture 30 to the remote system 20 via the communication link 22 using the communication subsystem 16. The processor 18 may execute code for handling a communication protocol, e.g. a multi-layered protocol, on the communication link 22. For example, the processor 18 may include code for transferring the digital picture 30 via the communication link 22 using Internet protocols. In one embodiment, the processor 18 uses the Internet file transfer protocol (FTP) to transfer the digital picture 30 to the remote system 20. In another embodiment, the processor 18 uses the Internet hypertext transfer protocol (HTTP) to transfer the digital picture 30 to the remote system 20.

The communication subsystem 16 enables communication via the communication link 22 according to the physical implementation of the communication link 22, e.g. cellular, phone line, Bluetooth, 802.11(b), Wi-Fi, etc. For example, if the communication link 22 is a cellular link then the communication subsystem 16 includes circuitry, e.g. RF transmitter/receiver, modulator, encoder/decoder, etc., for cellular communication. The processor 18 may include the appropriate firmware for handling the physical implementation of the communication link 22.

FIG. 3 illustrates a method for communication between the digital camera 10 and the remote system 20 in one embodiment. In this embodiment, the processor 18 transfers the digital picture 30 to the remote system 20 by performing a telephone call via the communication link 22 to an internet service provider (ISP) 40. An access number 26 for the ISP 40 is stored in a memory 24 in the digital camera 10. The memory 24 may be a persistent memory.

The processor 18 obtains the access number 26 from the memory 24 and establishes a dialup connection to the ISP 40 using the communication subsystem 16. The communication subsystem 16 may include circuitry for placing a cellular telephone call or a land line call depending on the embodiment. The dialup connection from the digital camera 10 to the ISP 40 provides the digital camera 10 with access to the Internet 100 and the remote system 20.

The processor 18 uploads the digital picture 30 to the remote system 20 using a dialup connection to the Internet 100 via the ISP 40. An internet address 28 for the remote system 20 is stored in the memory 24. For example, the internet address 28 may be a web address, i.e. URL, corresponding to the remote system 20, e.g. a URL of a personal web page on the remote system 20.

The digital camera 10 includes a user interface 52 that enables a user of the digital camera 10 to enter the access number 26 and the internet address 28 into the memory 24. The user interface 52 may be implemented using the same buttons/controls and displays that are used for setting camera exposures and displaying general information pertaining to picture acquisition.

In another embodiment, the digital camera 10 places a data call via the communication link 22 and transfers the digital picture 30 to the remote system 20 via the data call. An access number for the data call may be stored in the memory 24.

In another embodiment, the digital camera 10 includes the capability of communicating over a high speed connection, e.g. DSL. For example, hotel rooms may offer high speed internet connections which the digital camera 10 may use to transfer the digital picture 30 to the remote system 20.

The remote system 20 may store the digital pictures obtained from the digital camera 10 in one or more internal directories. In one embodiment, the remote system 20 includes a web server that generates a picture directory web page that enables selection of its directories via a web browser on the digital camera 10. The picture directory web page enables a user of the digital camera 10 to select among a set of pre-created directories on the remote system 20 or to create a new directory on the remote system 20 for holding the digital picture 30. For example, the picture directory web page may include a menu for a set of directory functions, e.g. copy, move, select directory, up a directory, keep but take off-line, etc.

A user of the digital camera 10 may specify how each obtained digital picture is to be handled. For example, the user of the digital camera 10 may specify the digital picture 30 as storage only, post to web, or keep local. If the user specifies keep local then the digital camera 10 does not transfer the digital picture 30 to the remote system 20. If the user specifies storage only or post to web then the digital camera 10 transfers the digital picture 30 to the remote system 20 along with a handling bit that specifies the storage only or post to web options. The remote system 20 decodes the handling bit and takes the appropriate action. If the digital picture 30 is marked storage only, then the remote system 20 stores the digital picture 30 in a directory on the remote system 20. If the digital picture 30 is marked post to web, then the remote system 20 posts the digital picture 30 to a web directory. The web directory may be specified in the message that carries the digital picture 30 to the remote system 20 or may be specified by the user, e.g. via a web page generated by the remote system 20.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A digital camera that stores a digital picture on a remote system via an existing communication infrastructure.

2. The digital camera of claim 1, comprising a communication subsystem that enables communication via a wireless communication link.

3. The digital camera of claim 1, comprising a communication subsystem that enables communication via a telephone link.

4. The digital camera of claim 1, comprising a communication subsystem that enables communication via a digital cellular link.

5. The digital camera of claim 1, comprising a communication subsystem that enables communication via a high speed communication link.

6. The digital camera of claim 1, wherein the remote system is a computer system.

7. The digital camera of claim 1, wherein the remote system is a web site.

8. The digital camera of claim 1, wherein the remote system is a web site that provides a personal web page for a user of the digital camera.

9. The digital camera of claim 1, comprising a memory for storing the digital picture internally while the existing communication infrastructure is unavailable.

10. The digital camera of claim 1, comprising a memory for storing an access number to the remote system.

11. The digital camera of claim 1, comprising a memory for storing an address for the remote system.

12. A system, comprising:
remote store;
digital camera that acquires a digital picture and that transfers the digital picture to the remote store via an existing communication infrastructure.

13. The system of claim 12, wherein the remote store is a personal computer system belonging to a user of the digital camera.

14. The system of claim 12, wherein the remote store is a web site that provides a storage service to a user of the digital camera.

15. The system of claim 12, wherein the digital camera includes a memory for storing the digital picture internally while the existing communication infrastructure is unavailable.

16. The system of claim 12, wherein the digital camera includes a memory for storing an access number to the remote system.

17. The system of claim 12, wherein the digital camera includes a memory for storing an address for the remote system.

18. A method for storing a digital picture acquired by a digital camera comprising transferring the digital picture from the digital camera to a remote system via an existing communication infrastructure.

19. The method of claim 18, wherein transferring comprises compressing the digital picture.

20. The method of claim 18, wherein transferring comprises transferring the digital picture using Internet protocols.
